(19) United States
(12) Patent Application Publication
(10) Pub. No.: US 2026/0249640 A1
(43) Pub. Date: Aug. 27, 2026

(54) SYSTEMS AND METHODS FOR RECYCLING WASTE MATERIAL FROM A PENCIL

(71) Applicant: Benjamin TISDALE, Hermon, ME (US)

(72) Inventor: Benjamin TISDALE, Hermon, ME (US)

(21) Appl. No.: 19/065,415

(22) Filed: Feb. 27, 2025

(51) Int. Cl. B43K 19/18; B09B 3/20; B09B 3/35; B09B 101/85; B43K 19/14; B43K 19/16

(52) U.S. Cl. CPC B43K 19/18; B09B 3/20; B09B 3/35; B43K 19/14; B43K 19/16; B09B 2101/85

(57) ABSTRACT

A system for recycling waste material from a pencil sharpener includes: a collector being configured for holding the waste material from the pencil sharpener, the waste material including a mixture of pigment shavings and shell shavings; a sizer being configured for reducing the size of the pigment shavings relative to the size of the shell shavings; and a separator being configured for separating the pigment shavings from the shell shavings based on the difference in the size of the pigment shavings relative to the size of the shell shavings.

### TECHNICAL FIELD

The present disclosure relates to pencil manufacturing, and more specifically to recycling waste material from a pencil.

### BACKGROUND

The normal process of using a pencil creates waste materials. These waste materials can be used in various ways, including, for example, in the production of a recycled pencil.

### SUMMARY

In some embodiments, a system for recycling waste material from a pencil sharpener includes: a collector being configured for holding the waste material from the pencil sharpener, the waste material including a mixture of pigment shavings and shell shavings; a sizer being configured for reducing the size of the pigment shavings relative to the size of the shell shavings; and a separator being configured for separating the pigment shavings from the shell shavings based on the difference in the size of the pigment shavings relative to the size of the shell shavings.

In some embodiments, a method of recycling waste material from a pencil sharpener comprises the steps of collecting the waste material, the waste material comprising pigment shavings and shell shavings, reducing the size of the pigment shavings, and separating the pigment shavings from the shell shavings.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

For a more complete understanding of various embodiments of the disclosed subject matter, reference is now made to the following descriptions taken in connection with the accompanying drawings, in which:

FIG. 1 illustrates a perspective view of a system for manufacturing pencils, according to embodiments of the present disclosure.

FIG. 2 illustrates an aerial view of a separator, according to embodiments of the present disclosure.

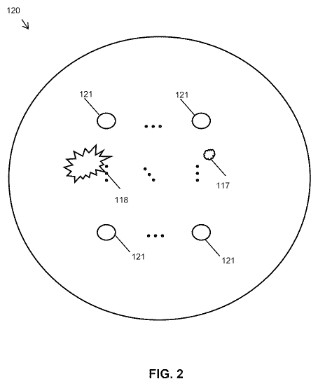

FIG. 3 illustrates a flow diagram of a method for manufacturing pencils, according to embodiments of the present disclosure.

FIG. 4 illustrates a perspective view of a system for manufacturing pencils, according to embodiments of the present disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as described and as defined by the appended claims.

### DETAILED DESCRIPTION

Among other things, the present disclosure provides various systems and methods of manufacturing pencils.

A pencil is an elongated writing instrument that typically includes an inner core composed of a writing material, such as graphite or other pigment, and an outer casing (or shell) composed of a suitable structural material, such as wood. Pencil “graphite” often includes clay material as well as other additives. For purposes herein, “graphite” means either graphite, graphite and clay, or a combination of graphite with clay or other additives typically found in a pencil. Some pencils can include additional components and materials such as a painted body, an eraser, coloring agents, or the like. Pencils may have a variety of shapes (e.g., cylindrical, hexagonal, or rectangular) and sizes (e.g., thin or thick, generally suitable for hand-held operation). In operation, one or both ends of the pencils is sharpened to expose a portion of the writing material, which can be manipulated for writing by the user gripping the outer shell.

Often, the process of sharpening a pencil involves trimming off the end of the pencil in such a way that the graphite or other writing material is left at a relatively sharp point at the end of the pencil, sticking out further than the pencil's wood. In the process of sharpening a pencil, the sharpener shaves off wood and graphite from the pencil itself. The shaved-off wood and graphite are typically discarded after enough accumulation. That is, the shaved-off wood and graphite never get used for their intended purpose as a pencil. One goal of the present disclosure is to provide systems and methods to use this shaved-off wood and graphite. Another goal of the present disclosure is to provide systems and methods for using other discarded wood and graphite, from sources other than a pencil such as recycled paper, construction sites, lumber mills, waste batteries or other industrial processes.

In some embodiments, system 100 can process wood or other shell materials. Further, in some embodiments, system 100 can process other pigment materials besides graphite. While certain references made herein refer to wood or graphite, it should be understood the components of system 100 can similarly process other shell materials or pigment materials in the same or similar ways.

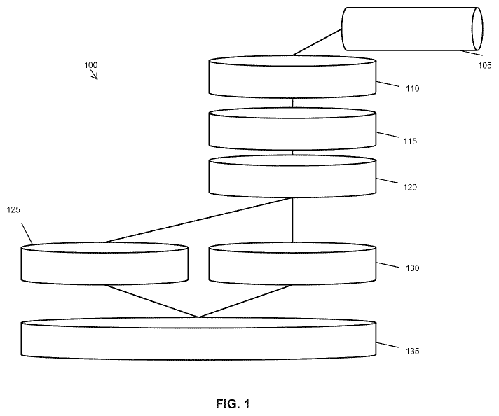

Turning now to FIG. 1, a system for recycling waste material from a pencil sharpener 100 in accordance with some embodiments of the present disclosure is illustrated. System 100 includes a sharpener 105, a collector 110, a pigment sizer 115, a separator 120, a pigment former 125, a shell former 130, and a combiner 135.

In some embodiments, the sharpener 105 can be used to sharpen a pencil. In some embodiments, sharpener 105 is a simple blade positioned at an angle where the user rotates the pencil against the blade. In some embodiments, the sharpener can be a manually cranked apparatus where the blade spins relative to the pencil when the user operates a crank. In some embodiments, the sharper is an electric motor-powered blade. In some embodiments, pencil sharpener 105 is configured to sharpen pencils by removing the wood and graphite near the used surface of a pencil, or from the end of an unused, unsharpened pencil. In other embodiments, for example, sharpener 105 can be a prism sharpener, linear blade sharpener, or a planetary sharpener. The removed shell material and pigment material can be collected in the collector 110.

Collector 110 is shaped and positioned to collect the shavings (e.g., wood, graphite, and/or other raw materials) from the sharpener. Collector 110 can additionally or alternatively include an aperture for a user to supply raw materials from an external source, such as a different pencil sharpener or from the waste stream of a different pencil making process. In some embodiments, collector 110 collects graphite and wood shavings from sharpener 105. In some embodiments, collector 110 collects graphite and wood from a source or sources other than sharpener 105, such as a different sharpener, a wood processing facility, graphite processing facility, pencil processing facility, or any other location where wood or graphite are processed. In some embodiments, collector 110 can be constructed in many different shapes, such as spherical, cubical, cylindrical, or prismatic. In some embodiments, collector 110 has an opening on its top where wood and graphite shavings can be inserted from external sources. Collector 110 can be constructed separately from sharpener 105, or, alternatively, collector 110 can be coupled to sharpener 105 such that the wood and graphite shavings from sharpener 105 move into collector 110 during or after use of sharpener 105.

The wood and graphite shavings in collector 110, whether from a pencil sharpener or another source, may initially be mixed together. To facilitate the use of the raw materials in recycling applications (e.g., forming recycled pencils), it may be desirable to separate the wood shavings from the graphite shavings. However, separating the wood and graphite shavings from each other may be challenging and/or tedious, for example, when using manual techniques. Moreover, the wood and graphite shavings may have similar physical characteristics (e.g., the wood and graphite shavings may initially have a similar size and shape), adding to the challenge of separating the raw materials.

Embodiments disclosed herein may address these challenges by leveraging the fact that the pigment material (e.g., graphite) tends to be more brittle than the casing material (e.g., wood). Due to their different physical properties, applying physical force (e.g., a grinding force) to the mixture of graphite and wood shavings tends to decrease the size of the graphite shavings at a greater rate than the wood shavings. Over time, as the physical force is applied, the graphite shavings become distinguishable in size and shape from the wood shavings. Once the graphite shavings have been sufficiently reduced in size relative to the wood shavings, it may be possible to separate them based on their difference in size, e.g., by using a separator with holes in it (e.g., a perforated plate, a screen, or the like), where the holes are larger than the graphite shavings but smaller than the wood shavings.

For example, system 100 may include a pigment sizer 115 and a separator 120 to separate the mixture of wood shavings and graphite shavings in collector 110. In some embodiments, pigment sizer 115 is contained inside the collector 110 and in other embodiments, pigment sizer 115 is not contained inside the collector. The pigment sizer can be used to apply force to the graphite and wood shavings in such a way as to reduce the particle size of the graphite. For example, in some embodiments, the force applied by pigment sizer 115 is configured to break down the graphite shavings but not break down wood shavings, thus reducing the size of the graphite particles but not reducing the size of the wood shavings. In some embodiments, pigment sizer 115 is configured in a shape approximating a small rolling pin. In some embodiments, pigment sizer 115 is in a form other than a small rolling pin, such as a mortar and pestle system, a ball mill, or a file. Graphite shavings can be broken down at a faster rate than wood shavings due to the different material properties of these two materials. For example, graphite is generally more brittle than wood and thus forces of a certain magnitude can break down graphite without breaking down wood (or breaking down the wood more slowly than the graphite). Once the graphite size is reduced, the graphite and wood can be introduced to a separator 120.

In some embodiments, collector 110, pigment sizer 115, and other components of system 100 are configured to operate with batches of graphite shavings and wood shavings. In this configuration, graphite shavings and wood shavings do not pass into pigment former 125 or shell former 130 until sufficient graphite shavings and/or wood shavings are collected to form a pencil.

In some embodiments, collector 110, pigment sizer 115, and other components of system 100 are configured to operate with continuous streams of graphite shavings and wood shavings. In this configuration, graphite shavings and wood shavings continuously pass into pigment former 125 and shell former 130, respectively, where the graphite and wood are accumulated until sufficient graphite shavings and/or wood shavings are collected to form a pencil.

In some embodiments, after the graphite shavings are introduced to the pigment sizer, the graphite shavings and wood shavings are introduced to separator 120. In some embodiments, separator 120 separates the graphite shavings and wood shavings based on the size of the particles. Separator 120 includes at least one perforated surface with one or more holes 121. The perforated surface may include a perforated plate, screen, sieve, strainer, or the like. Holes 121 may be substantially circular, square, or other suitable shape. Holes 121 may be associated with a diameter, which for the case of a circular hole may correspond to the ordinary diameter and for a non-circular hole may correspond to the size of the largest object that can fit through the hole. In some embodiments, the diameter of separator holes 121 is larger than the diameter, or maximum length, of the graphite shavings, but the diameter of separator holes 121 is smaller than the diameter, or maximum length, of the wood shavings. When constructed this way, graphite shavings can pass through the separator holes 121 but the wood shavings cannot pass through. For example, in some embodiments, the separator holes 121 are between 1 and 10 millimeters. In some embodiments, the separator holes 121 are between 3 and 6 millimeters. In some embodiments, the separator holes 121 are about 4.5 millimeters. When constructed this way, separator 120 separates the graphite shavings from the wood shavings. Graphite shavings that pass through separator 120 form graphite stream 122, and the wood shavings that remain form wood stream 124. To keep the raw materials moving through separator holes 121, an agitating force such as vibration, forced air, mechanical force, centrifugal force, or the like, may be applied to separator 120 and/or the raw materials within separator 120. The force may be powered manually (e.g., using a crank) or by an electric motor. The level of agitating force may be selected to achieve a desired rate of separation and may be variable.

Once the raw materials from are separated using separator 120, the separated raw materials can be collected and used for a variety of purposes. In nonlimiting embodiments described below, the separated raw materials are used to form a recycled pencil using pigment former 125, shell former 130, and combiner 135. However, it is to be understood that the separated raw materials can be recycled in various other ways, e.g., the recycled wood can be used to make paper or construction material, the recycled graphite can be used for industrial applications (e.g., lubricants), or the like.

Returning now to FIG. 1, in some embodiments, graphite stream 122 is introduced to pigment former 125. In the pigment former, graphite from the graphite stream can be arranged into a cylindrical formation to form a graphite tube 126. In some embodiments where the pigment is not graphite, the pigment shavings are formed into a recycled pigment tube 126. The graphite may be compressed, bound, glued, or otherwise coupled together such that the graphite remains in the graphite tube formation after coupling. In some embodiments, the graphite is mixed before it is combined to form the graphite tube 126. In some embodiments, graphite tube 126 is heat-tempered or otherwise heated to enable the graphite tube to be effective for writing. In some embodiments, a wax or oil is applied to the graphite tube to enable the graphite tube to be effective for writing. In some embodiments, epoxy resin or a different suitable binding agent are applied to graphite tube 126.

In some embodiments, wood stream 124 is introduced to shell former 130. Shell former 130 can contain a compression chamber that compresses the wood shavings into a recycled pencil shell 132 by using a pencil shell mold. Pencil shell 132 can include a hollow portion 134, that is approximately the size and shape of the graphite tube 126. Pencil shell 132 can be formed around a removable insert. The removable insert can be coupled to the pencil shell mold. The removable insert can be shaped such that when the removable insert is removed, hollow portion 134 is appropriately sized to receive graphite tube 126. In some embodiments, before the removable insert is removed, epoxy or a different binding agent can be dispensed into the hollow portion of the pencil shell. In some embodiments, shell former 130 contains a tub grinder or a different apparatus configured to reduce the size of the wood shavings. The size of the wood shavings can be important when forming the pencil shell; if the wood shavings are too large, forming a smooth pencil shell can be challenging. A smooth pencil shell can be important so as to enable comfortable use of the pencil shell by a user. In some embodiments, using a tub grinder or other size-reducing apparatus to reduce the size of the wood shavings can help enable the creation of a smooth pencil shell. In some embodiments, sharpener 105 is configured to create wood shavings that are already of appropriate size when considering formation of the pencil shell 136. In some embodiments, the compression chamber is configured to tightly compact the wood shavings into pencil shell 132, such that relatively large wood shavings can be compacted tightly enough to form a smooth pencil shell, without reducing the size of the wood shavings in a different step. The wood shavings can be glued, bound, compressed, or otherwise manipulated so that the separate wood particles are coupled together when shaped into the pencil shell 132.

Graphite tube 126 and pencil shell 132 are then introduced to combiner 135. In combiner 135, graphite tube 126 is inserted into the hollow portion of pencil shell 132. Graphite tube 126 can be coupled to pencil shell 132. In some embodiments, the graphite tube can be substantially held in place inside the pencil shell by friction. In some embodiments, the graphite tube is held in place by epoxy resin or a different suitable binding agent. In some embodiments, the hollow portion of the pencil shell is larger in diameter than the graphite tube, such that the graphite tube can be inserted more easily. The pencil shell can then be further compressed around the graphite tube to firmly hold the graphite tube in place.

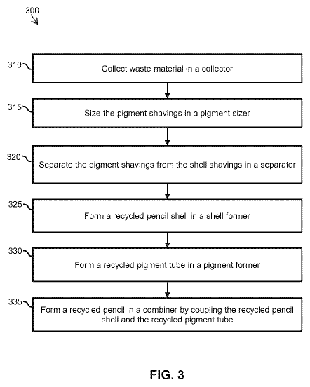

FIG. 3 shows a flow diagram of a method 300 for recycling waste material from a pencil sharpener according to some embodiments.

At method step 310, waste material is collected in a collector. The waste material may include, for example, wood shavings and/or graphite shavings from a pencil that was sharpened. The waste material may also include a different type of shell shaving besides wood, or a different type of pigment shaving besides graphite. As discussed above, the collector may also collect waste material from a source other than a pencil sharpener.

At method step 315, pigment shavings are sized in a pigment sizer. The pigment sizer may be located within the collector. The pigment sizer may also be located outside of the collector. The pigment sizer applies force to the shell shavings and pigment shavings. As discussed above, the pigment sizer may be in many different forms including a shape approximating a small rolling pin. Due to the different material properties between the shell shavings and pigment shavings, the pigment shavings break down easier than the shell shavings. The pigment sizer may size the pigment shavings by applying a force to the shell shavings and the pigment shavings that is sufficient to break down the pigment shavings, but not break down the shell shavings.

At method step 320, the pigment shavings are separated from the shell shavings in a separator. As discussed above, the separator may separate the pigment shavings from the shell shavings based on the different sizes of the shavings. The separator may include separator holes with a diameter larger than the maximum length of the pigment shavings, but smaller than the maximum length of the shell shavings. When configured in this manner, pigment shavings can pass through the separator holes while the shell shavings cannot. In some embodiments, the separator holes are between 1 and 10 millimeters. In some embodiments, the separator holes are between 3 and 6 millimeters. In some embodiments, the separator holes are about 4.5 millimeters.

In some embodiments, method 300 may conclude at step 320 and the separated materials may be stored, transported, and/or used for a variety of purposes. Optionally, as explained below, method 300 may proceed to method steps 325-335 for forming a recycled pencil from the separated materials.

At method step 325, a recycled pencil shell is formed in a shell former. The shell former may collect the shell shavings and compress or otherwise form the shell shavings into a pencil shell by using a pencil mold. The pencil shell may be formed around a removable insert. The removable insert may then be removed after the shell is formed, leaving a hollow portion inside of the pencil shell where the recycled pigment tube may later be inserted.

At method step 330, a recycled pigment tube is formed in a pigment former. The pigment former may arrange the pigment shavings into a cylindrical formation and compress or otherwise form the pigment shavings into a recycled pigment tube. The pigment shavings may be mixed before formation into the recycled pigment tube. In some embodiments, the recycled pigment tube is heat-tempered or otherwise heated to enable the recycled pigment tube to be effective for writing. In some embodiments, a wax or oil is applied to the recycled pigment tube to enable the recycled pigment tube to be effective for writing.

At method step 335, a recycled pencil is formed in a combined by coupling the recycled pencil shell and the recycled pigment tube. The combiner may insert the recycled pigment tube into the hollow portion of the pencil shell. In some embodiments the recycled pigment tube is coupled to the pencil shell by epoxy or a different resin, through friction, or through other means.

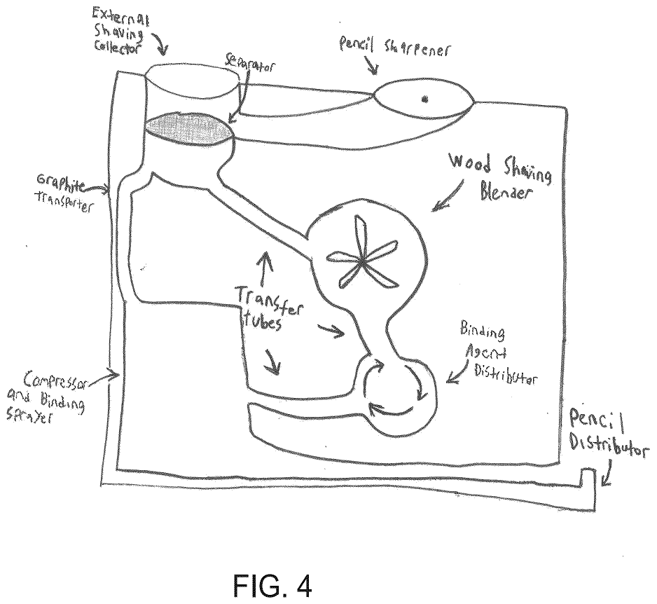

As shown in FIG. 4, in some embodiments the system 100 includes a pencil sharpener, a shaving collector, a separator, a blender, a binding agent distributor, a compressor and binding sprayer, and a pencil distributor.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. An apparatus for recycling waste material from a pencil sharpener, comprising
a collector configured to hold the waste material from the pencil sharpener, the waste material comprising a mixture of pigment shavings and shell shavings;
a sizer configured to reduce the size of the pigment shavings relative to the size of the shell shavings; and
a separator configured to separate the pigment shavings from the shell shavings based on the difference in the size of the pigment shavings relative to the size of the shell shavings.

2. The apparatus of claim 1, further comprising:
a shell former configured to reduce the size of the shell shavings and form a recycled pencil shell from the size-reduced shell shavings;
a pigment former configured to form a recycled pigment tube from the size-reduced pigment shavings;
a combiner configured to couple the recycled pencil shell and the recycled pigment tube, thereby forming a recycled pencil.

3. The apparatus of claim 1, wherein the sizer applies a physical force to the mixture that reduces the size of the pigment shavings at a faster rate than the size of the shell shavings.

4. The apparatus of claim 1, wherein the pigment shavings comprise graphite.

5. The apparatus of claim 1, wherein the shell shavings comprise wood.

6. The apparatus of claim 1, wherein the pencil sharpener is coupled to the collector.

7. The apparatus of claim 2, wherein the shell former comprises a blender.

8. The apparatus of claim 2, wherein the recycled pencil shell comprises a hollow portion, the hollow portion configured to receive the recycled pigment tube.

9. The apparatus of claim 2, wherein the shell former is configured to apply a binding agent to the shell shavings.

10. The apparatus of claim 2, wherein the combiner is configured to apply a binding agent to the recycled pigment tube and the recycled pencil shell.

11. A method for recycling waste material from a pencil sharpener, comprising the steps of:
collecting the waste material, the waste material comprising pigment shavings and shell shavings;
reducing the size of the pigment shavings; and
separating the pigment shavings from the shell shavings.

12. The method of claim 11, further comprising the steps of:
reducing the size of the shell shavings following separation of the pigment shavings from the shell shavings;
forming the recycled pencil shell from the size-reduced shell shavings;
forming a recycled pigment tube from the size-reduced pigment shavings;
forming a recycled pencil by coupling the recycled pencil shell and the recycled pigment tube.

13. The method of claim 11, wherein the size of the pigment shavings is reduced by applying a physical force to the pigment shavings.

14. The method of claim 11, wherein the pigment shavings comprise graphite.

15. The method of claim 11, wherein the shell shavings comprise wood.

16. The method of claim 11, wherein the waste material is collected in a waste collection bin of the pencil sharpener.

17. The method of claim 12, wherein reducing the size of the shell shavings comprises blending the shell shavings.

18. The method of claim 12, wherein the recycled pencil shell comprises a hollow portion, the hollow portion configured to receive the recycled pigment tube.

19. The method of claim 12, further comprising applying a binding agent to the shell shavings.

20. The method of claim 12, wherein forming the recycled pencil comprises applying a binding agent to the recycled pigment tube and the recycled pigment shell.
